(19) United States
(12) Patent Application Publication
(10) Pub. No.: US 2011/0071067 A1
(43) Pub. Date: Mar. 24, 2011

(54) Washing And Cleaning Agent

(75) Inventors: Gerd Reinhardt, Kelkheim (DE); Hans Juergen Scholz, Alzenau (DE); Rico Czaja, Leipzig (DE); Thomas Greiner-Stoeffele, Soemmerda (DE); Marc Struhalla, Leipzig (DE)

(73) Assignees: CLARIANT FINANCE (BVI) LIMITED, Tortola (VG); C-LECTA, Leipzig (DE)

(21) Appl. No.: 12/993,032

(22) PCT Filed: May 12, 2009
(86) PCT No.: PCT/EP2009/003348

§ 371 Date: Dec. 8, 2010

(30) Foreign Application Priority Data
May 17, 2008 (DE) 10 2008 024 084.2

(51) Int. Cl. C11D 3/386

(52) U.S. Cl. 510/320

(57) ABSTRACT

The invention relates to washing and cleaning agents comprising a combination of chlorophyllase and a further hydrolase, preferably a lipase, particularly a galactolipase. The combination of chlorophyllase and galactolipase improves the cleaning power, particularly for chlorophyll-containing stains, compared to each of the two enzymes alone.

The present invention relates to enzyme-containing washing or cleaning compositions which, as well as customary constituents, comprise combinations of chlorophyllases and of at least one further hydrolase, preferably a lipase, more preferably a galactolipase.

As well as the ingredients indispensable for the washing process, such as surfactants and builder materials, washing compositions generally comprise further constituents which can be summarized by the term “washing assistants” and which comprise such different active ingredient groups as foam regulators, graying inhibitors, bleaches and dye transfer inhibitors. Such assistants also include substances which promote the surfactant performance by the enzymatic degradation of stains present on the textile. The same also applies mutatis mutandis to cleaning compositions for hard surfaces. In addition to the proteases, which promote protein removal, and the fat-cleaving lipases, the amylases are of particular significance, having the task of facilitating the removal of starch-containing stains by the catalytic hydrolysis of the starch polysaccharide, as are the cellulases.

Further customary ingredients of washing and cleaning compositions are active ingredients intended to bring about the removal of colored stains such as tea or red wine stains. For this purpose, inorganic peroxygen compounds, especially hydrogen peroxide and solid peroxygen compounds which dissolve in water to release hydrogen peroxide, such as sodium perborate and sodium carbonate perhydrate, have been used for some time as oxidizing agents for disinfection and bleaching purposes. The oxidizing action of these substances in dilute solution depends greatly on the temperature. At relatively low temperatures, the oxidizing action of the inorganic peroxygen compounds can be improved by addition of what are known as bleach activators.

Useful substances here are in particular compounds from the substance classes of the N- or O-acyl compounds, for example polyacylated alkylenediamines or carboxylic esters. Addition of these substances allows the bleaching action of aqueous peroxide liquors to be enhanced to such an extent that essentially the same effects as with the peroxide liquor alone at 95° C. already occur at temperatures below 60° C.

Frequently, reactions of enzymes and bleach system are complementary; frequently, synergistic effects are even observed. A particularly persistent group of stains is that of chlorophyll-containing stains, especially grass or foliage stains, which can be removed to a sufficient degree neither by the enzymes used to date nor by the bleaching system. It is found to be problematic here that the chlorophyll is not in free form but combined with hydrophobic or protein-containing plant constituents which makes it more difficult for the bleach systems to attack the chromophore.

Chlorophyllases (EC 3.1.1.14), which are hydrolytic enzymes which catalyze the cleavage of chlorophyll or pheophytin to chlorophyllide or pheophorbide and phytol, have been known for about 100 years. The reaction of the chlorophyllase with chlorophyll significantly improves the water solubility of the chromophoric system.

Lipases are now used routinely in washing and cleaning composition formulations for removal of lipid or grease stains. In this context, these enzymes remove the grease-containing stains by hydrolysis of one or more ester bonds of triacylglycerides, and of phospholipids. A specific group of lipases is that of the galactolipases, which cleave one or more ester bonds of galactolipids exclusively, or in addition to triacylglycerides and phospholipids.

The use especially of galactolipases in commercial washing and cleaning composition formulations has not been described to date.

In galactolipids, one or more galactose radicals are bonded to the sn-3 position of diacylglyerides. Galactolipids are the main constituents of photo-synthetically active membranes and are therefore encountered in plants and photosynthetically active bacteria in particular. The chlorophyll molecules are embedded into these galactolipid membranes. Galactolipases are encountered, for example, in plants, where they occur principally in the chloroplasts. Further sources of galactolipolytic enzymes are lipases from the digestive tract of mammals, and these activities have also been detected in microorganisms.

It has now been found that, surprisingly, the combination of chlorophyllases and further hydrolases, specifically lipases and especially galactolipases, leads to unexpected synergistic improvements in performance on chlorophyll-containing stains, such that this enzyme combination is particularly suitable for use in washing and cleaning compositions.

The invention provides washing or cleaning compositions comprising a combination of a chlorophyllase and of a hydrolase, preferably a lipase and especially a galactolipase.

The use of this combination of a chlorophyllase and of at least one further hydrolase, preferably a lipase and especially a galactolipase, increases the cleaning performance of washing and cleaning compositions, especially with respect to colored, chlorophyll-based stains, especially in aqueous washing and cleaning solutions which comprise a peroxygen compound. The term “cleaning performance with respect to colored stains” should be understood in its widest meaning and encompasses the bleaching of soil present on the textile, the bleaching of soil which has been detached from the textile and is present in the wash liquor, and the oxidative destruction of textile dyes which are present in the wash liquor and have been detached from textiles under the washing conditions, before they can become attached to differently colored textiles. Even in the case of use in cleaning solutions for hard surfaces, this term is understood to mean both the bleaching of soil present on the hard surface, especially tea, and the bleaching of soil which has been detached from the hard surface and is present in the dishwashing liquor.

One constituent present in the inventive washing or cleaning composition is a chlorophyllase. The chlorophyllases used are principally plant enzymes, preferably enzymes from the orange (Citrus sinensis) or from wheat (Triticum aestivum). For use in the inventive products, the enzymes can be produced by recombinant means, for example in Escherichia coli or Pichia pastoris, and then purified from the cytoplasmic crude extract or the culture supernatant by standard methods.

A further constituent present in the inventive washing or cleaning composition is a hydrolase, preferably a lipase, especially a galactolipase. The galactolipases used may firstly be of prokaryotic origin, for example from Pseudomonas sp. or Chromobacter sp. Alternatively, it is also possible to use eukaryotic galactolipases from yeasts, fungi, and from vegetable or animal sources, for example from Candida sp., beans (Phaseolus vulgaris), potatoes (Solanum tuberosum), guinea pig (Cavia porcellus), horse (Equus caballus) or human (Homo sapiens). For use in the inventive products, the enzymes can also be produced by recombinant means, for example in Escherichia coli or Pichia pastoris, and be purified from the cytoplasmic crude extract or the culture supernatant by standard methods.

An inventive washing or cleaning composition generally comprises in each case 0.0001 to 10 mg, preferably in each case 0.001 mg to 1.0 mg, especially in each case 0.02 to 0.3 mg, of chlorophyllase and further hydrolase per gram of the washing and cleaning composition.

The inventive washing and cleaning compositions, which may be present in the form of pulverulent solids, in subsequently compacted particulate form, or as homogeneous solutions or suspensions, comprise, apart from the enzymes mentioned, in principle, all known ingredients customary in such compositions. The inventive compositions may comprise surfactants, builder substances, additional bleaches based on organic and/or inorganic peroxygen compounds, additional bleach activators, bleach catalysts, water-miscible organic solvents, additional enzymes, sequestrants, electrolytes, pH regulators and further assistants, such as optical brighteners, graying inhibitors, dye transfer inhibitors, foam regulators, silver corrosion inhibitors, and dyes and fragrances. The inventive compositions may comprise one surfactant or a plurality of surfactants, especially useful surfactants being anionic surfactants, nonionic surfactants and mixtures thereof, but also cationic, zwitterionic and amphoteric surfactants.

Suitable nonionic surfactants are especially alkylglycosides and ethoxylation and/or propoxylation products of alkylglycosides or linear or branched alcohols having in each case 12 to 18 carbon atoms in the alkyl moiety and 3 to 20, preferably 4 to 10, alkyl ether groups. In addition, corresponding ethoxylation and/or propoxylation products of N-alkylamines, vicinal diols, fatty acid esters and fatty acid amides, which correspond to the long-chain alcohol derivatives mentioned with regard to the alkyl moiety, and also of alkylphenols having 5 to 12 carbon atoms in the alkyl radical, are usable.

The nonionic surfactants used are preferably alkoxylated, advantageously ethoxylated, especially primary alcohols having preferably 8 to 18 carbon atoms and an average of 1 to 12 mol of ethylene oxide (EO) per mole of alcohol, in which the alcohol radical may be linear or preferably 2-methyl-branched, or may contain linear and methyl-branched radicals in a mixture, as typically present in oxo alcohol radicals. Especially preferred, however, are alcohol ethoxylates with linear radicals from alcohols of native origin having 12 to 18 carbon atoms, for example from coconut alcohol, palm alcohol, tallow fat alcohol or oleyl alcohol, and an average of 2 to 8 EO per mole of alcohol. The preferred ethoxylated alcohols include, for example, C₁₂-C₁₄-alcohols with 3 EO or 4 EO, C₉-C₁₁-alcohols with 7 EO, C₁₃-C₁₅-alcohols with 3 EO, 5 EO, 7 EO or 8 EO, C₁₂-C₁₈-alcohols with 3 EO, 5 EO or 7 EO, and mixtures thereof, such as mixtures of C₁₂-C₁₄-alcohol with 3 EO and C₁₂-C₁₈-alcohol with 7 EO. The degrees of ethoxylation specified are statistical averages which may be a whole number or a fraction for a specific product. Preferred alcohol ethoxylates have a narrow homolog distribution (narrow range ethoxylates, NRE). In addition to these nonionic surfactants, it is also possible to use fatty alcohols with more than 12 EO. Examples thereof are (tallow) fatty alcohols with 14 EO, 16 EO, 20 EO, 25 EO, 30 EO or 40 EO. Especially in cleaning compositions for use in machine dishwashing processes, typically extremely low-foam compounds are used. These preferably include C₁₂-C₁₈-alkyl polyethylene glycol-polypropylene glycol ethers having in each case up to 8 mol of ethylene oxide and propylene oxide units in the molecule. However, it is also possible to use other known low-foam nonionic surfactants, for example C₁₂-C₁₈-alkyl polyethylene glycol-polybutylene glycol ethers having in each case up to 8 mol of ethylene oxide and butylene oxide units in the molecule, and also end group-capped alkyl polyalkylene glycol mixed ethers.

Particular preference is also given to the hydroxyl-containing alkoxylated alcohols, known as hydroxyl mixed ethers. The nonionic surfactants also include alkylglycosides of the general formula RO(G)ₓ in which R is a primary straight-chain or methyl-branched, especially 2-methyl-branched, aliphatic radical having 8 to 22 and preferably 12 to 18 carbon atoms, and G is a glycose unit having 5 or 6 carbon atoms, preferably glucose. The degree of oligomerization x, which states the distribution of monoglycosides and oligoglycosides, is any number—which, as a parameter to be determined analytically, may also assume fractional values—between 1 and 10; x is preferably 1.2 to 1.4. Likewise suitable are polyhydroxy fatty acid amides.

A further class of nonionic surfactants used with preference, which are used either as the sole nonionic surfactant or in combination with other nonionic surfactants, especially together with alkoxylated fatty alcohols and/or alkylglycosides, is that of alkoxylated, preferably ethoxylated or ethoxylated and propoxylated, fatty acid alkyl esters, preferably having 1 to 4 carbon atoms in the alkyl chain, especially fatty acid methyl esters.

Nonionic surfactants of the amine oxide type, for example N-cocoalkyl-N,N-dimethylamine oxide and N-tallowalkyl-N,N-dihydroxyethylamine oxide, and of the fatty acid alkanolamide type, may also be suitable. The amount of these nonionic surfactants is preferably not more than that of the ethoxylated fatty alcohols, especially not more than half thereof.

Useful further surfactants include what are known as gemini surfactants. This is generally understood to mean those compounds which possess two hydrophilic groups per molecule. These groups are generally separated from one another by a “spacer”. This spacer is generally a carbon chain which should be long enough that the hydrophilic groups have a sufficient separation that they can act independently of one another. In exceptional cases, the term “gemini surfactants” is understood to mean not only such “dimeric” but also correspondingly “trimeric” surfactants. Suitable gemini surfactants are, for example, sulfated hydroxyl mixed ethers or dimer alcohol bissulfates and ether sulfates and trimer alcohol trissulfates and ether sulfates. End group-capped dimeric and trimeric mixed ethers are notable especially for their bi- and polyfunctionality. However, it is also possible to use gemini polyhydroxy fatty acid amides or poly(polyhydroxy fatty acid amides).

Suitable anionic surfactants are especially soaps and those which contain sulfate or sulfonate groups. Useful surfactants of the sulfonate type preferably include C₉-C₁₃-alkylbenzenesulfonates, olefinsulfonates, i.e. mixtures of alkene- and hydroxyalkanesulfonates, and also disulfonates as obtained, for example, from C₁₂-C₁₈-monoolefins with a terminal or internal double bond by sulfonation with gaseous sulfur trioxide and subsequent alkaline or acidic hydrolysis of the sulfonation products. Also suitable are alkanesulfonates which are obtained from C₁₂-C₁₈-alkanes, for example by sulfochlorination or sulfoxidation with subsequent hydrolysis or neutralization. Also suitable are the esters of alpha-sulfo fatty acids (ester sulfonates), for example the alpha-sulfonated methyl esters of hydrogenated coconut fatty acids, palm kernel fatty acids or tallow fatty acids, which are prepared by alpha-sulfonating the methyl esters of fatty acids of vegetable and/or animal origin having 8 to 20 carbon atoms in the fatty acid molecule and subsequently neutralizing to give water-soluble mono-salts. These are preferably the alpha-sulfonated esters of the hydrogenated coconut fatty acids, palm fatty acids, palm kernel fatty acids or tallow fatty acids, though it is also possible for sulfonation products of unsaturated fatty acids, for example oleic acid, to be present in small amounts, preferably in amounts not above about 2 to 3% by weight. Especially preferred are alpha-sulfo fatty acid alkyl esters which have an alkyl chain having not more than 4 carbon atoms in the ester group, for example methyl esters, ethyl esters, propyl esters and butyl esters. Particularly advantageously, the methyl esters of the alpha-sulfo fatty acids (MES), but also the hydrolyzed disalts thereof, are used.

Further suitable anionic surfactants are sulfated fatty acid glyceryl esters, which are mono-, di- and triesters and mixtures thereof, as obtained in the preparation by esterification by a monoglycerol with 1 to 3 mol of fatty acid, or in the transesterification of triglycerides with 0.3 to 2 mol of glycerol. Preferred alk(en)yl sulfates are the alkali metal salts and especially the sodium salts of the sulfuric monoesters of the C₁₂-C₁₈ fatty alcohols, for example formed from coconut fatty alcohol, tallow fatty alcohol, lauryl alcohol, myristyl alcohol, cetyl alcohol or stearyl alcohol or the C₁₀-C₂₀ oxo alcohols, and those monoesters of secondary alcohols of this chain length.

Additionally preferred are alk(en)yl sulfates of the chain length mentioned, which comprise a synthetic, straight-chain alkyl radical prepared on a petrochemical basis, which possess analogous degradation behavior to the equivalent compounds based on fatty chemical raw materials. From the washing point of view, C₁₂-C₁₆-alkyl sulfates and C₁₂-C₁₅-alkyl sulfates, and also C₁₄-C₁₅-alkyl sulfates, are especially preferred. 2,3-Alkyl sulfates are also suitable anionic surfactants. Also suitable are the sulfuric monoesters of the straight-chain or branched C₇-C₂₁-alcohols ethoxylated with 1 to 6 mol of ethylene oxide, such as 2-methyl-branched C₉-C₁₁-alcohols with an average of 3.5 mol of ethylene oxide (EO) or C₁₂-C₁₈ fatty alcohols with 1 to 4 EO. The preferred anionic surfactants also include the salts of alkylsulfosuccinic acid, which are also referred to as sulfosuccinates or as sulfosuccinic esters, and the monoesters and/or diesters of sulfosuccinic acid with alcohols, preferably fatty alcohols and especially ethoxylated fatty alcohols. Preferred sulfosuccinates contain C₈-C₁₈ fatty alcohol radicals or mixtures thereof. Especially preferred sulfosuccinates contain a fatty alcohol radical which derives from ethoxylated fatty alcohols which are themselves nonionic surfactants. Particular preference is given in turn to sulfosuccinates whose fatty alcohol radicals derived from ethoxylated fatty alcohols with a narrow homolog distribution. Equally, it is also possible to use alk(en)ylsuccinic acid having preferably 8 to 18 carbon atoms in the alk(en)yl chain or salts thereof.

Useful further anionic surfactants include fatty acid derivatives of amino acids, for example of N-methyltaurine (taurides) and/or of N-methylglycine (sarcosides). Especially preferred are the sarcosides or the sarcosinates, and here in particular sarcosinates, of higher and optionally mono- or polyunsaturated fatty acids, such as oleyl sarcosinate. Useful further anionic surfactants include especially soaps. Especially suitable are saturated fatty acid soaps, such as the salts of lauric acid, myristic acid, palmitic acid, stearic acid, hydrogenated erucic acid and behenic acid, and also especially soap mixtures derived from natural fatty acids, for example coconut fatty acids, palm kernel fatty acids or tallow fatty acids. Together with these soaps or as a replacement for soaps, it is also possible to use the known alkenylsuccinic salts.

The anionic surfactants, including the soaps, may be present in the form of the sodium, potassium or ammonium salts thereof, or else as the soluble salts of organic bases, such as mono-, di- or triethanolamine. The anionic surfactants are preferably present in the form of the sodium or potassium salts thereof, especially in the form of the sodium salts.

Surfactants are present in inventive washing compositions in proportions of preferably 5% by weight to 50% by weight, especially of 8% by weight to 30% by weight, whereas compositions for cleaning hard surfaces, especially for machine cleaning of dishware, have lower surfactant contents of up to 10% by weight, especially up to 5% by weight and preferably in the range from 0.5% by weight to 3% by weight.

An inventive composition preferably comprises at least one water-soluble and/or water-insoluble, organic and/or inorganic builder. The water-soluble organic builder substances include polycarboxylic acids, especially citric acid and sugar acids; monomeric and polymeric aminopolycarboxylic acids, especially methylglycinediacetic acid, nitrilotriacetic acid and ethylenediaminetetraacetic acid, and also polyaspartic acid, polyphosphonic acids, especially aminotris(methylenephosphonic acid), ethylenediaminetetrakis(methylenephosphonic acid) and 1-hydroxyethane-1,1-diphosphonic acid, polymeric hydroxyl compounds such as dextrin, and also polymeric (poly)carboxylic acids, especially the polycarboxylates obtainable by oxidation of polysaccharides or dextrins, polymeric acrylic acids, methacrylic acids, maleic acids and copolymers thereof, which may also contain small proportions of polymerizable substances without a carboxylic acid functionality in copolymerized form. The relative molecular mass of the homopolymers of unsaturated carboxylic acids is generally between 3000 and 200 000, and that of the copolymers between 2000 and 200 000, preferably 30 000 to 120 000, based in each case on the free acid. A particularly preferred acrylic acid-maleic acid copolymer has a relative molecular mass of 30 000 to 100 000. Commercial products are, for example, Sokalan™ CP 5, CP 10 and PA 30 from BASF. Suitable, though less preferred, compounds of this class are copolymers of acrylic acid or methacrylic acid with vinyl ethers such as vinyl methyl ethers, vinyl esters, ethylene, propylene and styrene, in which the proportion of the acid is at least 50% by weight. The water-soluble organic builder substances used may also be terpolymers which contain, as monomers, two unsaturated acids and/or salts thereof, and, as a third monomer, vinyl alcohol and/or an esterified vinyl alcohol or a carbohydrate. The first acidic monomer or salt thereof derives from a monoethylenically unsaturated C₃-C₈-carboxylic acid and preferably from a C₃₋₄-monocarboxylic acid, especially from (meth)acrylic acid. The second acidic monomer or salt thereof may be a derivative of a C₄-C₈-dicarboxylic acid, particular preference being given to maleic acid, and/or a derivative of an allylsulfonic acid which is 2-substituted by an alkyl or aryl radical. Such polymers generally have a relative molecular mass between 1000 and 200 000. Further preferred copolymers are those which have, as monomers, preferably acrolein and acrylic acid/acrylic salts or vinyl acetate. The organic builder substances may, especially to prepare liquid compositions, be used in the form of aqueous solutions, preferably in the form of 30 to 50 percent by weight aqueous solutions. All acids mentioned are generally used in the form of the water-soluble salts thereof, especially the alkali metal salts thereof.

Such organic builder substances may, if desired, be present in amounts up to 40% by weight, especially up to 25% by weight and preferably from 1% by weight to 8% by weight. Amounts close to the upper limit mentioned are preferably used in pasty or liquid, especially aqueous, inventive compositions.

Useful water-soluble inorganic builder materials include especially alkali metal silicates, alkali metal carbonates and alkali metal phosphates, which may be present in the form of their alkaline, neutral or acidic sodium or potassium salts. Examples thereof are trisodium phosphate, tetrasodium diphosphate, disodium dihydrogendiphosphate, pentasodium triphosphate, what is known as sodium hexametaphosphate, oligomeric trisodium phosphate having degrees of oligomerization of 5 to 1000, especially 5 to 50, and the corresponding potassium salts or mixtures of sodium and potassium salts. The water-insoluble, water-dispersible inorganic builder materials used are especially crystalline or amorphous alkali metal aluminosilicates, in amounts of up to 50% by weight, preferably not more than 40% by weight, and in liquid compositions especially of 1% by weight to 5% by weight. Among these, preference is given to the crystalline sodium aluminosilicates in detergent quality, especially zeolite A, P and optionally X, alone or in mixtures, for example in the form of a cocrystal of zeolites A and X (Vegobond®™ AX, a commercial product from Condea Augusta S.p.A.). Amounts close to the upper limit mentioned are preferably used in solid particulate compositions. Suitable aluminosilicates especially have no particles with a particle size greater than 30 μm and consist preferably to an extent of at least 80% by weight of particles having a particle size below 10 μm. The calcium binding capacity thereof is generally in the range from 100 to 200 mg of CaO per gram.

Suitable substitutes or partial substitutes for the aluminosilicate mentioned are crystalline alkali metal silicates, which may be present alone or in a mixture with amorphous silicates. The alkali metal silicates usable as builders in the inventive compositions preferably have a molar ratio of alkali metal oxide to SiO₂ of less than 0.95, especially of 1:1.1 to 1:12, and may be present in amorphous or crystalline form. Preferred alkali metal silicates are the sodium silicates, especially the amorphous sodium silicates, with a molar ratio of Na₂O:SiO₂ of 1:2 to 1:2.8. The crystalline silicates used, which may be present alone or in a mixture with amorphous silicates, are preferably crystalline sheet silicates of the general formula Na₂SixO₂x+1.y H₂O in which x, known as the modulus, is from 1.9 to 22, especially 1.9 to 4, and y is from 0 to 33, preferred values for x being 2, 3 or 4. Preferred crystalline sheet silicates are those in which x in the general formula mentioned assumes the values of 2 or 3. Especially preferred are both beta- and delta-sodium disilicates (Na₂Si₂O₅.y H₂O). It is also possible to use virtually anhydrous crystalline alkali metal silicates which have been prepared from amorphous alkali metal silicates and are of the abovementioned general formula in which x is from 1.9 to 2.1 in inventive compositions. In a further preferred embodiment of inventive compositions, a crystalline sodium sheet silicate with a modulus of 2 to 3 is used. Crystalline sodium silicates with a modulus in the range from 1.9 to 3.5 are used in a further preferred embodiment of inventive compositions. Crystalline sheet silicates of the above-specified formula (I) are sold by Clariant under the Na-SKS tradename, for example Na-SKS-1 (Na₂Si₂₂O₄₅.xH₂O, kenyaite), Na-SKS-2 (Na₂Si₁₄O₂₉.xH₂O, magadiite), Na-SKS-3 (Na₂Si₈O₁₇.xH₂O) or Na-SKS-4 (Na₂Si₄O₉.xH₂O, makatite). Among these, the following are suitable in particular: Na-SKS-5 (alpha-Na₂Si₂O₅), Na-SKS-7 (beta-Na₂Si₂O₅ natrosilite), Na-SKS-9 (Na₂Si₂O₅.3H₂O), Na-SKS-10 (NaHSi₂O₅.3H₂O, kanemite), Na-SKS-11 (t-Na₂Si₂O₅) and Na-SKS-13 (NaHSi₂O₅), but especially Na-SKS-6 (delta-Na₂Si₂O₅). In a preferred configuration of inventive compositions, a granular compound composed of crystalline sheet silicate and citrate, of crystalline sheet silicate and abovementioned (co)polymeric polycarboxylic acid or of alkali metal silicate and alkali metal carbonate is used, as commercially available, for example, under the Nablon®™ 15 name.

Builder substances may optionally be present in the inventive compositions in amounts of up to 90% by weight. They are preferably present in amounts of up to 75% by weight. Inventive washing compositions have builder contents of especially 5% by weight to 50% by weight. In inventive compositions for the cleaning of hard surfaces, especially for machine cleaning of dishware, the content of builder substances is especially 5% by weight to 88% by weight, and preference is given to using no water-insoluble builder materials in such compositions. In a preferred embodiment of inventive compositions for cleaning, especially machine cleaning, of dishware, 20% by weight to 40% by weight of water-soluble organic builder, especially alkali metal citrate, 5% by weight to 15% by weight of alkali metal carbonate and 20% by weight to 40% by weight of alkali metal disilicate are present.

Useful suitable peroxygen compounds include especially hydrogen peroxide and inorganic salts which release hydrogen peroxide under the washing conditions, which include the alkali metal perborates, percarbonates, persilicates and/or persulfates, such as Caroat, but also organic peracids or peracidic salts of organic acids, such as phthalimido-percaproic acid, perbenzoic acid or salts of diperdodecanedioic acid. If solid peroxygen compounds are to be used, they may be used in the form of powders or granules, which may also be coated in a manner known in principle. Peroxygen compounds are present in amounts of preferably up to 50% by weight, especially of 5% by weight to 30% by weight and more preferably of 8% by weight to 25% by weight. The addition of small amounts of known bleach stabilizers, for example of phosphonates, borates or metaborates, and metasilicates, and also magnesium salts such as magnesium sulfate, may be appropriate to the purpose.

The bleach activators used may especially be compounds which, under perhydrolysis conditions, give rise to aliphatic peroxocarboxylic acids having preferably 1 to 10 carbon atoms, especially 2 to 4 carbon atoms, and/or optionally substituted perbenzoic acid. Suitable substances are those which bear O- and/or N-acyl groups of the number of carbon atoms mentioned and/or optionally substituted benzoyl groups. Preference is given to polyacylated alkylenediamines, especially tetraacetylethylenediamine (TAED), acylated triazine derivatives, especially 1,5-diacetyl-2,4-dioxohexahydro-1,3,5-triazine (DADHT), acylated glycolurils, especially tetraacetylglycoluril (TAGU), N-acylimides, especially N-nonanoylsuccinimide (NOSI), acylated phenolsulfonates, especially n-nonanoyl- or isononanoyloxybenzenesulfonate (n- or iso-NOBS), carboxylic anhydrides, especially phthalic anhydride, acylated polyhydric alcohols, especially triacetin, ethylene glycol diacetate, 2,5-diacetoxy-2,5-dihydrofuran and enol esters, and also acetylate sorbitol and mannitol, acylated sugar derivatives, especially pentaacetylglucose (PAG), pentaacetylfructose, tetraacetylxylose and octaacetyllactose, and also acetylated, optionally N-alkylate glucamine and gluconolactone, and/or N-acylated lactams, for example N-benzoylcaptolactam. Hydrophilically substituted acyl acetals and acyl lactams are likewise used with preference.

Such bleach activators may be present within the typical range of amounts, preferably in amounts of 0.5% by weight to 10% by weight, especially 1% by weight to 8% by weight, based on overall composition. In addition to the conventional bleach activators listed above, or in their stead, it is also possible for sulfonimines and/or bleach-boosting transition metal salts or transition metal complexes to be present as what are known as bleach catalysts. The useful transition metal compounds include especially manganese-, iron-, cobalt-, ruthenium- or molybdenum-salen complexes and the known N-analog compounds thereof, manganese-, iron-, cobalt-, ruthenium- or molybdenum-carbonyl complexes, manganese complexes, iron complexes, cobalt complexes, ruthenium complexes, molybdenum complexes, titanium complexes, vanadium complexes and copper complexes with nitrogen-containing tripod ligands, cobalt-, iron-, copper- and ruthenium-ammine complexes. Bleach-boosting transition metal complexes, especially with the central atoms Mn, Fe, Co, Cu, Mo, V, Ti and/or Ru, are used in customary amounts, preferably in an amount of up to 1% by weight, especially of 0.0025% by weight to 0.25% by weight and more preferably of 0.01% by weight to 0.1% by weight, based in each case on overall composition.

In addition, the inventive washing and cleaning compositions may comprise proteases, further lipases, amylases and/or cellulases. The usable proteases include the enzymes which are obtainable from microorganisms, especially bacteria or fungi, and have a pH optimum in the alkaline range. Protease is preferably used in the inventive composition in such amounts that the finished composition has 100 PU/g to 7500 PU/g (protease units per gram, determined by the method described in Tenside 7, 125 (1970)), especially 125 PU/g to 5000 PU/g and more preferably 150 PU/g to 4500 PU/g. Usable proteases are commercially available, for example under the BLAP™, Savinase™, Esperase™, Maxatase™, Optimase™, Alcalase™, Durazym™, Everlase™, Maxapem© & or Purafect™ OxP names.

The amylases usable in inventive compositions, which are preferably used in combination with at least one further enzyme, include the enzymes which are obtainable from bacteria or fungi and have a pH optimum preferably in the alkaline range up to about pH 10. Usable commercial products are, for example, Termamyl™, Maxamyl™, Duramyl™ or Purafect™ OxAm. Amylase is used in the inventive composition preferably in such amounts that the finished composition has 0.01 KNU/g to 2 KNU/g (“Kilo Novo Units” per gram according to the standard method of the company Novo, where 1 KNU is the amount of enzyme which degrades 5.26 g of starch at pH 5.6 and 37° C., based on the method described by P. Bernfeld in S. P. Colowick and N. D. Kaplan, Methods in Enzymology, Volume 1, 1955, page 149), especially 0.015 KNU/g to 1.8 KNU/g and more preferably 0.03 KNU/g to 1.6 KNU/g. If the inventive composition comprises an amylase, it is preferably selected from the amylases modified by genetic engineering.

Any further lipase additionally present in the inventive composition is an enzyme obtainable from microorganisms, especially bacteria or fungi. Lipase is used in the inventive composition preferably in such amounts that the finished composition has a lipolytic activity in the range from 10 LU/g to 10 000 LU/g (“lipase activity units” per gram, determined via the enzymatic hydrolysis of tributyrin at 30° C. and pH 7 by the method specified in EP 258 068), especially 80 LU/g to 5000 LU/g and more preferably 100 LU/g to 1000 LU/g. Commercially available lipases are, for example, Lipolase™, Lipomax™, Lumafast™ and Lipozym™.

The cellulose usable in accordance with the invention is likewise one of the enzymes which is obtainable from bacteria or fungi and has a pH optimum preferably in the almost neutral to weakly alkaline pH range from 6 to 9.5. They are used in the inventive composition preferably in such amounts that the finished composition has a cellulolytic activity of 0.05 IU/g to 1.5 IU/g (“international units” per gram, based on the enzymatic hydrolysis of sodium carboxymethylcellulose at pH 9.0 and 40° C., as described in Agric. Biol. Chem. 53, 1275 (1989) by S. Ito et al.), especially 0.07 IU/g to 1.4 IU/g and more preferably 0.1 IU/g to 1.3 IU/g. Suitable commercial products are, for example, Celluzyme™ from the manufacturer Novo Nordisk, or KAC™ from Kao.

Since several enzymes are to be used in the inventive composition, this can be done by incorporating the two or more separate enzymes, or enzymes which have been formulated separately in a known manner, or by means of two or more enzymes formulated together in a granule.

Useful enzymes additionally usable in the compositions include those from the class of the cutinases, pullulanases, hemicellulases, oxidases, laccases and peroxidases, and mixtures thereof. Particularly suitable active enzymatic ingredients are those obtained from fungi or bacteria, such as Bacillus subtilis, Bacillus licheniformis, Bacillus lentus, Streptomyces griseus, Humicola lanuginosa, Humicola insolens, Pseudomonas pseudo-alcaligenes, Pseudomonas cepacia or Coprinus cinereus. The enzymes may be adsorbed on carriers and/or embedded in coating substances, in order to protect them from premature inactivation. They are present in the inventive washing or cleaning compositions preferably in amounts of up to 5% by weight, especially of 0.2% by weight to 4% by weight.

The organic solvents usable in addition to water in the inventive compositions, especially when they are in liquid or pasty form, include alcohols having 1 to 4 carbon atoms, especially methanol, ethanol, isopropanol and tert-butanol, diols having 2 to 4 carbon atoms, especially ethylene glycol and propylene glycol, and mixtures thereof, and the ethers derivable from the compound classes mentioned. Such water-miscible solvents are present in the inventive compositions preferably in amounts not exceeding 30% by weight, especially of 6% by weight to 20% by weight.

In addition, the compositions may comprise further constituents customary in washing and cleaning compositions. These optional constituents include especially enzyme stabilizers, graying inhibitors, dye transfer inhibitors, foam inhibitors and optical brighteners, and also dyes and fragrances. In order to bring about protection from silver corrosion, silver corrosion inhibitors may be used in the inventive cleaning compositions for dishware. An inventive cleaning composition for hard surfaces may additionally comprise abrasive constituents, especially from the group comprising quartz flours, wood flours, polymer flours, chalks and glass microspheres, and mixtures thereof. Abrasives present in the inventive cleaning compositions preferably do not exceed 20% by weight, and are especially from 5% by weight to 15% by weight.

To establish a desired pH which does not arise automatically by the mixing of the remaining components, the inventive compositions may comprise system-compatible and environmentally compatible acids, especially citric acid, acetic acid, tartaric acid, malic acid, lactic acid, glycolic acid, succinic acid, glutaric acid and/or adipic acid, but also mineral acids, especially sulfuric acid, or bases, especially ammonium hydroxides or alkali metal hydroxides. Such pH regulators are present in the inventive compositions in amounts preferably not exceeding 20% by weight, especially of 1.2% by weight to 17% by weight.

The useful dye transfer inhibitors for use in inventive textile washing compositions are especially polyvinylpyrrolidones, polyvinylimidazoles, polymeric N-oxides such as poly(vinylpyridine N-oxide), and copolymers of vinylpyrrolidone with vinylimidazole.

Graying inhibitors have the task of keeping the soil detached from the textile fiber suspended in the liquor. For this purpose, water-soluble colloids usually of organic nature are suitable, for example starch, size, gelatin, salts of ethercarboxylic acids or ethersulfonic acids of starch or of cellulose, or salts of acidic sulfuric esters of cellulose or of starch. Water-soluble polyamides containing acidic groups are also suitable for this purpose. In addition, it is possible to use other starch derivatives than those mentioned above, for example aldehyde starches. Preference is given to using cellulose ethers, such as carboxymethylcellulose (sodium salt), methylcellulose, hydroxyalkylcellulose, and mixed ethers, such as methylhydroxyethylcellulose, methylhydroxypropylcellulose, methylcarboxymethylcellulose and mixtures thereof, for example in amounts of 0.1 to 5% by weight, based on the compositions.

To enhance the cleaning performance, the inventive compositions may especially comprise soil release polymers, which are generally composed of carboxylic acid units and optionally polymeric diol units, and contain, for example, ethylene terephthalate and polyoxyethylene terephthalate groups. Other monomer units, for example propylene glycol, polypropylene glycol, alkylene- or alkenylenedicarboxylic acids, isophthalic acid, carboxy- or sulfo-substituted phthalic acid isomers, may be present in the soil release polymer. It is also possible to use end group-capped derivatives, i.e. polymers which have neither free hydroxyl groups nor free carboxyl groups, but instead bear, for example, C₁₋₄-alkyl groups or have been terminally esterified with monobasic carboxylic acids, for example benzoic acid or sulfobenzoic acid. Also suitable are polyesters which, as well as oxyethylene groups and terephthalic acid units, contain 1,2-propylene, 1,2-butylene and/or 3-methoxy-1,2-propylene groups, and also glycerol units, and are endgroup-capped with C₁-C₄-alkyl groups, the soil release polymers which are formed from ethylene terephthalate and polyethylene oxide terephthalate and have a molar mass of 900 to 9000, where the polyethylene glycol units have molar masses of 300 to 3000 and the molar ratio of ethylene terephthalate to polyethylene oxide terephthalate is 0.6 to 0.95, the polyesters which have polypropylene terephthalate and polyoxyethylene terephthalate units and are at least partly end group-capped by C₁₋₄-alkyl or acyl radicals, the sulfoethyl-end group-capped terephthalate-containing soil release polyesters, the soil release polyesters which are prepared by sulfonating unsaturated end groups and have terephthalate, alkylene glycol and poly-C₂₋₄-glycol units, cationic soil release polyesters with amine, ammonium and/or amine oxide groups, and the cationic soil release polyesters with ethoxylated, quaternized morpholine units. Likewise suitable are polymers formed from ethylene terephthalate and polyethylene oxide terephthalate, in which the polyethylene glycol units have molar masses of 750 to 5000 and the molar ratio of ethylene terephthalate to polyethylene oxide terephthalate is 50:50 to 90:10, and also polymers with molar mass 15 000 to 50 000 formed from ethylene terephthalate and polyethylene oxide terephthalate, where the polyethylene glycol units have molar masses of 1000 to 10 000 and the molar ratio of ethylene terephthalate to polyethylene oxide terephthalate is 2:1 to 6:1.

Inventive textile washing compositions may comprise, as optical brighteners, derivatives of diaminostilbenedisulfonic acid or the alkali metal salts thereof. Suitable examples are salts of 4,4′-bis(2-anilino-4-morpholino-1,3,5-triazinyl-6-amino)stilbene-2,2′-disulfonic acid or compounds which are of equivalent structure and bear, instead of the morpholino group, a diethanolamino group, a methylamino group, an anilino group or a 2-methoxyethylamino group. In addition, brighteners of the substituted diphenylstyryl type may be present, for example the alkali metal salts of 4,4′-bis(2-sulfostyryl)diphenyl, of 4,4-bis(4-chloro-3-sulfo-styryl)diphenyl or of 4-(4-chlorostyryl)-4′-(2-sulfostyryl)diphenyl. It is also possible to use mixtures of the aforementioned optical brighteners.

Especially in the case of use in machine processes, it may be advantageous to add customary foam inhibitors to the composition. Suitable foam inhibitors are, for example, soaps of natural or synthetic origin, which have a high proportion of C₁₈-C₂₄-fatty acids. Suitable non-surfactant foam inhibitors are, for example, organopolysiloxanes and mixtures thereof with microfine, optionally silanized, silica, and also paraffins, waxes, microcrystalline waxes and mixtures thereof with silanized silica or bis(fatty acid) alkylenediamides. It is advantageous also to use mixtures of different foam inhibitors, for example those of silicones, paraffins or waxes. The foam inhibitors, especially silicone- and/or paraffin-containing foam inhibitors, are preferably bound to a granular, water-soluble or -dispersible carrier substance. Especially preferred are mixtures of paraffins and bistearylethylenediamide.

Inventive solid compositions can be produced in a known manner, for example by spray-drying or granulation, in which case the enzymes and any further thermally sensitive ingredients, for example bleaches, may be added separately at a later stage. To produce inventive compositions with increased bulk density, especially in the range from 650 g/l to 950 g/l, a known process having an extrusion step is preferred. A further preferred production with the aid of a granulation process is described in European patent EP 0 642 576.

To produce inventive compositions in tablet form, which may be monophasic or polyphasic, single-colored or multicolored, and may especially consist of one layer or of more than one layer, especially of two layers, the procedure is preferably to mix all the constituents—optionally of one layer in each case—with one another in a mixer, and to press the mixture by means of conventional tableting presses, for example excentric presses or rotary presses. Especially in the case of multilayer tablets, it may be advantageous when at least one layer is precompressed. A tablet produced in this way preferably has a weight of 10 g to 50 g, especially of 15 g to 40 g. The three-dimensional shape of the tablets is as desired, and they may be round, oval or angular, intermediate forms also being possible. Corners and edges are advantageously rounded off. Round tablets preferably have a diameter of 30 mm to 40 mm. Especially the size of tablets of angular or cuboidal configuration, which are predominantly introduced via the dosage apparatus, for example of the machine dishwasher, depends on the geometry and the volume of the dosage apparatus. Illustrative preferred embodiments have a base area, of (20 to 30 mm)×(34 to 40 mm), especially of 26×36 mm or of 24×38 mm.

Liquid or pasty inventive washing or cleaning compositions in the form of solutions comprising customary solvents are generally produced by simple mixing of the ingredients, which can be introduced in substance or as a solution into an automated mixer.

The production of chlorophyllase used in accordance with the invention by cloning is known from the literature (IntEnz Enzyme Nomenclature EC 3.1.1.1.14), for example according to Tsuchiya et al., Proc. Natl. Acad. Sci. USA 96, 15362-15367 (1999). Examples of chlorophyllases are known in the form of Arabidopsis thaliana AT1G19670 or AT5G43860. Galactolipases are known under reference EC 3.1.1.26, CAS registry number:37278-40-3.

### EXAMPLES

### 1. Expression of a Recombinant Chlorophyllase in E. coli

The gene of the chlorophyllase was amplified by the polymerase chain reaction from a cDNA sample with the oligonucleotides Citrus_CHL_fwd_Ndel and Citrus_CHL_rev_Xhol as primers. For directed cloning into an appropriate expression vector, for example pET28a (Novagen), recognition sequences for restriction endonucleases (Ndel and Xhol) were simultaneously incorporated into the oligonucleotides. The vector pET28a contains the bacteriophage T7 promoter system, and codes for a C-terminal and/or N-terminal His tag. The amplified DNA was digested with the two restriction endonucleases and fractionated and purified using an agarose gel, by cutting the appropriate band out of the gel and extracting it. The digested and gel-purified PCR product was ligated with the expression vector cut and dephosphorylated with the same restriction endonucleases. The ligated DNA was subsequently used for the transformation of electrocompetent E. coli DH10B (Invitrogen). Positive transformants were identified by colony PCR, restriction analysis and sequencing.

For the expression of the chlorophyllase, E. coli tuner (DE3) pLacl (Novagen) was transformed with a plasmid clone which contains a verified insert. Cultures were grown in 2xYT medium with added kanamycin (50 μg/ml) and chloramphenicol (34 μg/ml) at 37° C. At an optical density of about 0.8, the expression was induced by adding 1 mM isopropylthio-galactoside (IPTG). Subsequently, the cultivation was continued at 30° C. for four to six hours.

### 2. Purification of a Recombinant Chlorophyllase from E. coli

The cells were harvested by centrifugation and resuspended in 20 mM sodium phosphate buffer (pH 7.4) with 500 mM NaCl, 20 mM imidazole and 0.5 mg/ml of lysozyme, and incubated at room temperature. The cells were digested by freezing in liquid nitrogen with subsequent thawing at about 42° C. three times, or by means of ultrasound. The mixture was centrifuged, and the chlorophyllase was present as a soluble protein in the supernatant. The chlorophyllase was subsequently purified further by means of metal affinity chromatography. To this end, the metal affinity matrix was equilibrated with 20 mM sodium phosphate buffer (pH 8) with 500 mM NaCl, 20 mM imidazole and 10% glycerol, and washed with the buffer mentioned after sample application, and then the chlorophyllase was eluted with 20 mM sodium phosphate buffer (pH 8) with 500 mM NaCl, 250 mM imidazole and 10% glycerol.

### 3. Measurement of the Chlorophyllase Activity

The activity of the chlorophyllase expressed was determined using the elevated water solubility of the chlorophyllide reaction product which forms. The reaction was performed in a 100 μl batch which contains 100 μm chlorophyll from spinach (Fluka), 20% acetone (v/v) and 100 mM Na-MOPS pH 7.0. The reaction mixture was incubated at 37° C. while shaking for 60 min and then stopped by adding 50 μl of acetone, 50 μl of n-hexane and 5 μl of tris-Cl (2 M; pH 9.0). The mixture was homogenized thoroughly by shaking vigorously and then the phase separation was accelerated by centrifugation for 2 minutes. As a result of the reaction of the chlorophyllase, the water-soluble chlorophyllide was present in the lower aqueous phase, and the unconverted chlorophyll in the upper organic phase. For quantification, 80 μl of the aqueous phase were admixed with 120 μl of methanol, and the fluorescence of the excited chlorophyllide was measured (Ex 355 nm; Em 660 nm). The amount of chlorophyllide formed was determined using a standard calibration curve.

### 4. Expression of a Recombinant Galactolipase in Pichia pastoris

The synthetic gene cassette of the human pancreas lipase related protein 2, of a galactolipase, flanked by recognition sites for the restriction endonucleases Kpnl and Pagl, was cloned into a Pichia expression vector, for example pGK1 or pGAPZα. For this purpose, both the synthetic gene and the appropriate expression vector, which was subsequently dephosphorylated, were digested with the restriction endonucleases according to the manufacturer's instructions. The digested nucleic acids were fractionated by size and purified by means of agarose gel electrophoresis, and were then ligated with T4 DNA ligase according to the manufacturer's instructions. The ligated DNA was subsequently used for the transformation of electrocompetent E. coli DH10B. Positive transformants were identified by colony PCR, restriction analysis and sequencing.

For the expression of lipase, Pichia pastoris was transformed with a verified plasmid clone. The expression was detected on YPD plates with added tributyrin, on the basis of zone formation in the case of active lipase secretion. Subsequently, liquid cultures of lipase-active clones were made up in YPD medium, with added Zeocin (100 μg/l). The cultures were incubated while shaking at 30° C. for 48 to 72 hours. Thereafter, the cells were separated by centrifugation from the culture supernatant which contained the lipase. The culture supernatant was desalted by diafiltration and concentrated by lyophilization.

### 5. Measurement of Lipase Activity

The activity of the lipase was monitored by the increase in the absorbance at 405 nm during the hydrolysis of p-nitrophenyl butyrate pNP-C4 or p-nitrophenyl caprylate pNP-C8. The reaction was performed in a 1 ml batch which contained 2 mM of the p-nitrophenyl ester, 50 mM of potassium phosphate buffer (pH 8) and 0.1% Triton X-100. The increase in the absorbance at 405 nm was monitored continuously over a period of at least one minute. With the aid of the extinction coefficient of p-nitrophenol ε_{(pNP, 405 nm, pH 8)}=16.05 mM⁻¹ cm⁻¹, the volume activity was determined from the rise. One unit corresponds to the amount of enzyme which catalyzes the release of 1 μmol of p-nitrophenol within one minute in the above-described test batch at 22° C.

### 6. Determination of the Chlorophyllide Release from Chloroplasts

Chloroplasts for this assay were isolated from spinach leaves. For this purpose, fresh spinach leaves were triturated with sea sand in a mortar and homogenized in the mortar with 50 mM potassium phosphate buffer pH 8 and 0.33 M sucrose. The suspension was filtered through eight layers of gauze, and the cell fragments and the rest of the sand were removed by centrifuging at 200×g for one minute. The chloroplasts in the supernatant were subsequently pelletized by centrifuging at 1000×g for ten minutes. The chloroplast pellet was resuspended in 50 mM HEPES pH 7.6 with 2 mM EDTA, 1 mM MgCl₂ and 0.33 M sorbitol. The chlorophyll content is determined by measuring the absorbance at 652 nm in 80% acetone with ε=34.5 lg⁻¹ cm⁻¹.

The chlorophyllide release from chloroplasts was determined using the elevated water solubility of the reaction product. Chloroplasts corresponding to a chlorophyll content of 10 μg were incubated in a 150 μl reaction batch containing 50 mM potassium phosphate buffer pH 8, with different amounts of chlorophyllase (e.g. 250 ng) and/or lipase (e.g. 5 U of pNP-C4) at 40° C. for 60 min. Subsequently, the chloroplasts were pelletized and the chlorophyllide released was determined in the supernatant. The chlorophyllide was determined by measuring the absorbance at 652 nm or by measuring the fluorescence in 60% MeOH (Em 355 nm; Ex 655 nm).

### Results:

| | Control | | | |
|---|---|---|---|---|
| | (no | Chlorophyllase | Galactolipase | Chlorophyllase/ |
| | enzyme) | (example 2) | (example 4) | galactolipase |
| Chlorophyllide | 1.7% | 3.7% | 14.7% | 25.2% |
| released in the | | | | |
| supernatant | | | | |

### 7. Removal of Grass Stains on Textile Surfaces

To determine the washing power, cotton fabric in the form of swatches (WFK 10A) was stained homogeneously with freshly cut grass. For aging, the stains were stored dry with exclusion of light for at least 3 days.

Subsequently, the swatches (approx. 1 cm²) were first treated at 37° C. for 2 h with 500 μl of enzyme solution containing ˜3 μg of chlorophyllase (example 2) and ˜7.5 U (pNP-C4) of galactolipase (example 4). The swatches were subsequently washed by hand at 40° C. with a washing composition solution (Spee Color detergent, Henkel Dusseldorf). The degree of removal of the chlorophyll-containing stain was subsequently determined with a whiteness measuring instrument. The delta R value is reported as the difference of the treated test fabric from the untreated test fabric.

Wash results (% reflectance)

| | |
|---|---|
| Fabric washed with | |
| Spee color solution | 36.9% reflectance |
| Spee color solution plus chlorophyllase | 44.6% reflectance |
| Spee color solution plus chlorophyllase | 54.5% reflectance |
| plus galactolipase | |

It is evident that the inventive combination of a chlorophyllase with a hydrolase has a significantly improved cleaning performance than the use of a chlorophyllase without addition of a hydrolase.

1. A washing and cleaning composition comprising a chlorophyllase and a further hydrolase.

2. The washing and cleaning composition as claimed in claim wherein the hydrolase is a lipase.

3. The washing and cleaning composition as claimed in claim 1, wherein the hydrolase is a galactolipase.

4. The washing and cleaning composition as claimed in claim 1, which comprises 0.0001 mg to 10 mg of chlorophyllase and 0.0001 mg to 10 mg of hydrolase per gram.

5. The washing and cleaning composition as claimed in claim 1, which additionally comprises a protease.

6. The washing and cleaning composition as claimed in claim 1, which additionally comprises an amylase.

7. The use of a washing and cleaning composition as claimed in one or more of claims 1 to 6 for removing chlorophyll-containing stains.
